(19) United States
(12) Patent Application Publication
(10) Pub. No.: US 2025/0346371 A1
(43) Pub. Date: Nov. 13, 2025

(54) SPACECRAFT, GROUND STATION, AND ANTENNA

(71) Applicant: Hitachi, Ltd., Tokyo (JP)

(72) Inventors: Hisatoshi KIMURA, Tokyo (JP); Yosuke TANABE, Tokyo (JP); Tsukasa FUNANE, Tokyo (JP); Makoto ITO, Tokyo (JP); Koichi WATANABE, Tokyo (JP)

(21) Appl. No.: 19/174,176

(22) Filed: Apr. 9, 2025

(30) Foreign Application Priority Data
May 8, 2024 (JP) 2024-075853

(51) Int. Cl. B64G 1/24; B64G 1/10; B64G 1/36; B64G 1/44; H01Q 1/28; H01Q 3/34

(52) U.S. Cl. CPC B64G 1/244; B64G 1/1035; B64G 1/1057; B64G 1/36; B64G 1/443; H01Q 1/288; H01Q 3/34

(57) ABSTRACT

A spacecraft includes: an antenna unit 20 including a first layer film 11 and a second layer film 14, the first layer film 11 including a plurality of slit-like openings 13 in a film that does not allow transmission of an electromagnetic wave 16, and the second layer film 14 including a light receiving element 15 that detects a coherent electromagnetic wave transmitting through the plurality of openings; and a processing unit 21 configured to estimate an arrival direction of the electromagnetic wave from signal intensities of the electromagnetic waves detected by the light receiving element.

### CROSS-REFERENCE TO RELATED APPLICATION

This application claims priority to Japanese Patent Application No. 2024-075853 filed on May 8, 2024, the entire contents of which are incorporated by reference herein.

### BACKGROUND OF THE INVENTION

### 1. Field of the Invention

The present invention relates to a spacecraft that performs electromagnetic wave observation, a ground station, and an antenna.

### 2. Description of Related Art

In an electromagnetic wave observation system that is used for applications such as astronomic observation or remote sensing, it is required to accurately grasp an arrival direction of an electromagnetic wave from an electromagnetic source. A spatial resolution of an interferometric method (referred to as a rotational interferometric method) used in a very long baseline Interferometry (VLBI) observation system that is one aspect of a radio interferometer is a function between an element-antenna distance D and an observation wavelength λ, which is represented by λ/D (radian).

Further, a method of observing an electromagnetic wave with a single satellite (spacecraft) using the principle of the rotational interferometric method of the VLBI observation system is considered. As an example of deploying an element antenna in a single spacecraft, JP2015-80213A discloses a space-borne antenna system including a plurality of panels that are folded during transport to a space, are deployed in a space, and are movable relative to each other.

In the VLBI measurement developed to determine an astronomical position, by arranging an element antenna at a distance of 1000 km or more from the ground and causing points where interference between signal intensities of an antenna pair is strengthened using the rotation of the earth to overlap each other, a radio source can be investigated with a high spatial resolution. On the other hand, when an arrival direction of a radio wave from a radio source is identified from the ground using the rotational interferometric method in the single spacecraft disclosed in JP2015-80213A where the element antenna is installed, the element-antenna distance D depends on the size of the single spacecraft, and the spatial resolution is restricted by the element-antenna distance D. Therefore, the degree of freedom for the spatial resolution decreases. Accordingly, the present inventors newly found a multilayer interferometric method capable of estimating an arrival direction of an electromagnetic wave in the single spacecraft without being restricted by the element-antenna distance D, and investigated the installation on the spacecraft.

### SUMMARY OF THE INVENTION

A spacecraft according to one aspect of the present invention includes: an antenna unit including a first layer film and a second layer film, the first layer film including a plurality of slit-like openings in a film that does not allow transmission of an electromagnetic wave having a wavelength to be observed, and the second layer film including a light receiving element that detects a coherent electromagnetic wave transmitting through the plurality of openings; and a processing unit configured to estimate an arrival direction of the electromagnetic wave from signal intensity of the electromagnetic wave detected by the light receiving element.

There is provided a spacecraft that can estimate an arrival direction of an electromagnetic wave with a desired spatial resolution from a positional relationship between the slit-like opening and the light receiving element. Other objects and new characteristics will be clarified with reference to description of the present specification and the accompanying drawings.

### BRIEF DESCRIPTION OF THE DRAWINGS

FIG. 1 is a schematic configuration diagram illustrating a spacecraft;

FIG. 2A is a diagram illustrating a multilayer interferometric method;

FIG. 2B is a diagram illustrating the multilayer interferometric method;

FIG. 2C is a diagram illustrating the multilayer interferometric method;

FIG. 3 is a diagram illustrating the multilayer interferometric method;

FIG. 4 is a block diagram illustrating an electromagnetic wave observation system;

FIG. 5 is a configuration example of a first layer film and a second layer film that configure an antenna unit;

FIG. 6 is an example of a triangular opening;

FIG. 7 is an equivalent circuit example of a software wireless device;

FIG. 8 is a functional block diagram illustrating an arrival direction estimation process of an electromagnetic wave by a processor;

FIG. 9A is a configuration example of an antenna unit including five light receiving elements in a light receiving element group;

FIG. 9B is a diagram illustrating incidence angle dependence of a signal intensity of each of the light receiving elements;

FIG. 10A is a functional block diagram illustrating the arrival direction estimation process of the electromagnetic wave by the processor;

FIG. 10B is a configuration example of an antenna unit where a reference light receiving element is provided;

FIG. 10C is a diagram illustrating a method of estimating an incidence angle;

FIG. 11 is a functional block diagram illustrating the arrival direction estimation process of the electromagnetic wave by the processor;

FIG. 12 is a functional block diagram illustrating the arrival direction estimation process of the electromagnetic wave by the processor;

FIG. 13 is a side view illustrating the spacecraft;

FIG. 14 is a bird's-eye view illustrating the spacecraft;

FIG. 15 is a flow of estimating a radio source direction in an electromagnetic wave observation system;

FIG. 16 is a diagram illustrating the flow of FIG. 15;

FIG. 17 is a flow of estimating a radio source direction using a rotational interferometric method and a multilayer interferometric method in combination;

FIG. 18 is a diagram illustrating a first modification example;

FIG. 19 is a diagram illustrating a second modification example;

FIG. 20 is a diagram illustrating a third modification example;

FIG. 21 is a configuration example of an electromagnetic wave monitoring system; and

FIG. 22 is a diagram illustrating a fourth modification example.

### DESCRIPTION OF EMBODIMENTS

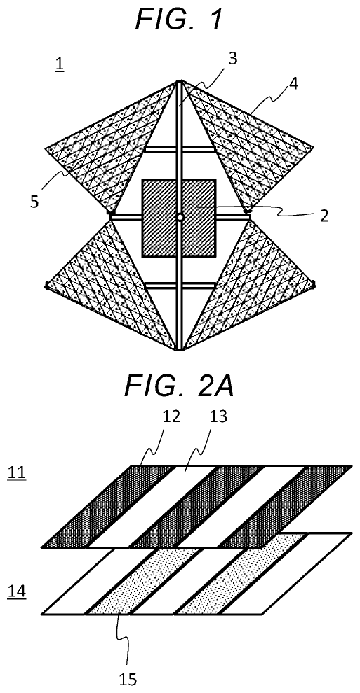

FIG. 1 illustrates a schematic configuration of the spacecraft. A spacecraft 1 is a three-dimensional spacecraft having a virtual regular polyhedron shape with a substantially center of the spacecraft as an origin. A satellite housing 2 is equipped with deployable beams (hereinafter, beams) 3. In the space, the beams 3 are deployed, and a thin film 4 is stretched. In the thin film 4, for example, a plurality of patch antennas 5 can be arranged. By synchronizing phases of the patch antennas 5, a transmitting and receiving antenna having high directivity can be configured. The details of the structure of the three-dimensional spacecraft are disclosed in Japanese Patent Application No. 2023-105999 by the same applicant.

In the interferometric measurement according to the present embodiment, the spacecraft 1 that has a three-dimensional structure and includes a multilayer film is used. For example, a configuration where a first layer film is the thin film 4 and a second layer film is a surface of the satellite housing 2 can be adopted. As a result, the number of necessary films can be reduced. Alternatively, in a spacecraft where the thin film 4 is deployed in multiple regions, a configuration where the first layer film is an external thin film (film far from the satellite housing 2) and the second layer film is an internal thin film (film close to the satellite housing 2) can be adopted. In the interferometric measurement according to the present embodiment, diffracted waves of arriving electromagnetic waves are generated in the first layer film, and an interference pattern of the diffracted waves is measured by an antenna installed in the second layer film. The generated interference pattern changes depending on an incidence angle θ of an electromagnetic wave. Therefore, an arrival direction of an electromagnetic wave can be estimated based on the interference pattern. The interferometric method according to the present embodiment is called a multilayer interferometric method.

### (Principle of Multilayer Interferometric Method)

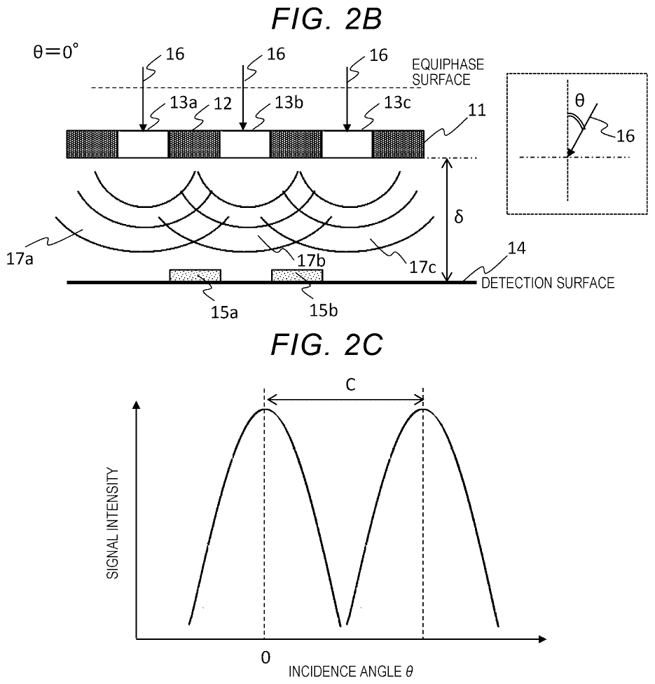

The multilayer interferometric method will be described using FIGS. 2A to 2C. FIG. 2A is a schematic diagram illustrating a configuration of an antenna unit for performing the interferometric measurement by the multilayer interferometric method. A first layer film 11 includes a plurality of slit-like openings 13 in a film that does not allow transmission of an electromagnetic wave in an observation wavelength. A portion of the film that does not allow the transmission of the electromagnetic wave is called a blocking portion 12. A second layer film 14 includes a light receiving element 15 that detects an electromagnetic wave transmitting through the openings 13 of the first layer film 11. In order to simplify the description, FIG. 2A illustrates an example where the first layer film 11 and the second layer film 14 are arranged parallel to each other, but the present invention is not limited to this arrangement. In addition, when the slit-like opening 13 is rectangular, it is preferable that the light receiving element 15 extends in the same direction as a direction in which the opening 13 extends. However, the slit-like opening 13 may be a shape where interference of diffracted waves from the first layer film 11 can be detected by the light receiving element 15 of the second layer film 14.

FIG. 2B schematically illustrates a state where the electromagnetic wave transmitting through the first layer film 11 is detected by the light receiving element 15. An electromagnetic source of an electromagnetic wave 16 to be observed is positioned sufficiently far from the antenna unit. Therefore, the electromagnetic wave 16 arrives as a plane wave having an aligned phase. Here, in order to simplify the description, an example where an equipotential surface of the electromagnetic wave 16 is parallel to the first layer film 11, that is, an incidence angle θ of the electromagnetic wave 16 on the antenna unit is 0° is illustrated. The electromagnetic wave 16 is diffracted when transmitting through the opening 13 of the first layer film 11. A diffracted wave 17a from an opening 13a, a diffracted wave 17b from an opening 13b, and a diffracted wave 17c from an opening 13c are detected by light receiving elements 15a and 15b, respectively. The electromagnetic waves received by the light receiving elements 15a and 15b are received in a state where diffracted waves from the respective openings interfere with each other, and thus the intensity thereof increases only at one incidence angle θ. When the spacecraft 1 is rotated to continuously change the incidence angle θ, the intensity of the electromagnetic waves received by the light receiving elements 15a and 15b periodically changes. This state is illustrated in FIG. 2C. A position where the signal intensity is the maximum is determined depending on a relationship between the incidence angle θ and an attitude angle of the spacecraft 1. Therefore, the incidence angle θ can be identified from a distribution where the signal intensity is the maximum in the light receiving element while continuously rotating the spacecraft 1 to continuously change the incidence angle θ.

Here, in consideration of a case where a diffracted wave 17 from the opening 13 is detected by the light receiving element 15, a signal intensity S thereof is represented by (Expression 1).

$${s}_{m} = {\sum }_{l = 1}^{N} {s}_{l , m} = {\sum }_{l = 1}^{N} \frac{1}{\sqrt{{( {b}_{m} - {a}_{l} )}^{2} + {L}^{2}}} \cdot exp ( jk \sqrt{{( {b}_{m} - {a}_{l} )}^{2} + {L}^{2}} ) \cdot exp ( - j 2 π \cdot {a}_{l} \cdot sin θ / λ ) \cdot exp ( - j \qquad [ Expression 1 ]$$

Here, A₁=(a₁, 0) represents a position on an open surface, Bₘ=(bₘ, 0) represents a position on the light receiving element, k, θ, λ, and ω represent a wave number, an incidence angle, a wavelength, and a frequency of an electromagnetic wave, respectively, t represents the time, and j represents the imaginary unit.

(Expression 1) can be divided into a component Cₘ representing an interference fringe and a component Tₘ representing a time variation, which are represented by (Expression 2) and (Expression 3), respectively.

$${C}_{m} = {\sum }_{l = 1}^{N} \frac{1}{\sqrt{{( {b}_{m} - {a}_{l} )}^{2} + {L}^{2}}} \cdot exp ( jk \sqrt{{( {b}_{m} - {a}_{l} )}^{2} + {L}^{2}} ) \cdot exp ( - j 2 π \cdot {a}_{l} \cdot sin θ / λ ) \qquad [ Expression 2 ]$$

$${T}_{m} = exp ( - jwt ) \qquad [ Expression 3 ]$$

(Expression 2) represents that the component Cₘ representing an interference fringe is uniquely determined depending on the opening position aₗ, the light receiving element position bₘ, and the incidence angle θ and the wavelength λ of the electromagnetic wave.

From the above, the multilayer interferometric method has the following characteristics. First, in the rotational interferometric method, the spatial resolution is a function that is determined depending on the element-antenna distance D. On the other hand, in the multilayer interferometric method, a film pattern or the arrangement of the two films such as a distance (inter-film distance δ) between the first layer film 11 and the second layer film 14 or a detection surface position, or the position or the number of the light receiving element 15 can be used as a parameter for the measurement. That is, when an arrival direction of an electromagnetic wave from an electromagnetic source is identified in the single spacecraft, the antenna unit can be designed using various parameters without being restricted by the spatial resolution depending on the element-antenna distance D as in the rotational interferometric method. Therefore, a desired spatial resolution can be set. For example, when the inter-film distance δ varies, the incidence angle θ (refer to FIG. 2C) where the signal intensity increases varies. Accordingly, by designing the first layer film 11 and the second layer film 14 according to the desired spatial resolution, the antenna unit can be optimized.

On the other hand, in the multilayer interferometric method, the electromagnetic wave transmitting through the opening 13 is detected, and thus the signal intensity of the electromagnetic wave arriving at each of the light receiving elements 15 is weak. However, by increasing the number of the light receiving elements, this problem is easily solved. For example, when a plurality of the light receiving elements 15 are arranged such that the signal intensities are the maximum at the same incidence angle, outputs from the light receiving elements 15 may be combined. In addition, when incidence angles where the signal intensities of the plurality of light receiving elements 15 are the maximum vary depending on arrangement positions thereof, output timings of the plurality of light receiving elements 15 having different arrangement positions may be adjusted by a phase shifter or a delay circuit such that the signal intensities of the light receiving elements 15 are the maximum at the same incidence angle, and the outputs from the plurality of light receiving elements 15 of which the timings are adjusted may be combined. As a result, the signal intensity output from the antenna unit can be improved.

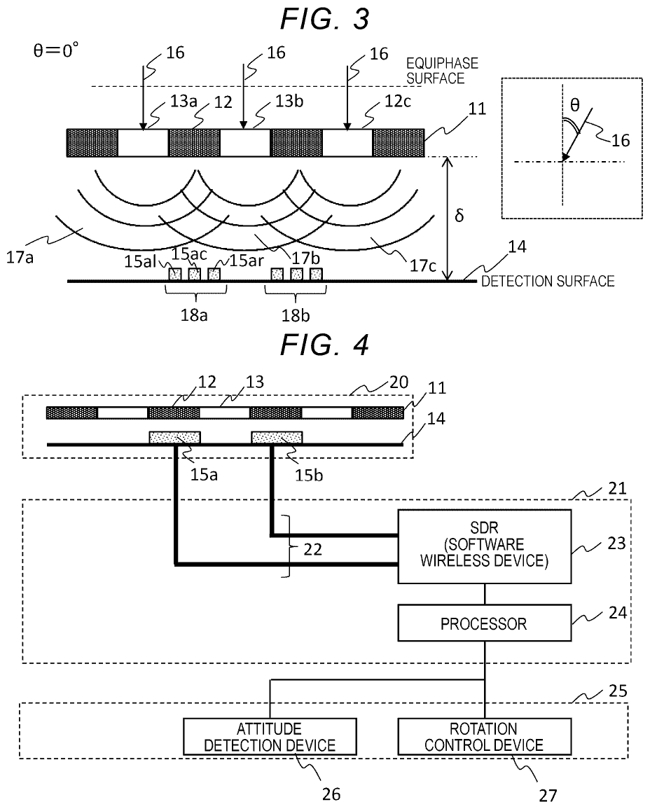

FIG. 3 is an example where a light receiving element group 18 is arranged in the second layer film 14 instead of the light receiving element 15. In this case, as illustrated in FIG. 2C, the signal intensity received by each of the light receiving elements configuring one light receiving element group periodically changes when the incidence angle θ continuously changes. Note that the size of the incidence angle θ where the signal intensity is the peak varies depending on the positions of the light receiving elements. That is, by reflecting an interference pattern between diffracted waves, the signal intensity detected by each of the light receiving elements configuring one light receiving element group varies.

Accordingly, by comparing the sizes of signal intensities of light receiving elements 15al, 15ac, and 15ar configuring a light receiving element group 18a while rotating the spacecraft 1 to continuously change the incidence angle θ, an arrival direction of an electromagnetic wave can be acquired from the relative signal intensities of the three light receiving elements and the attitude angle of the spacecraft 1. As a result, the spatial resolution can be further improved.

### (Electromagnetic Wave Observation System)

FIG. 4 is a block diagram illustrating an electromagnetic wave observation system for estimating an arrival direction of an electromagnetic wave. The spacecraft has various functions, and the electromagnetic wave observation system is a portion regarding the interferometric measurement according to the present embodiment that is extracted as a system. The electromagnetic wave observation system includes an antenna unit 20, a processing unit 21, and a satellite control unit 25. As described above, the antenna unit 20 includes the first layer film 11 including the blocking portion 12 and the opening 13 and the second layer film 14 including the light receiving element 15. The processing unit 21 includes a software wireless device (SDR: Software Defined Radio) and a processor 24. A signal received by the light receiving element 15 is transmitted to the SDR 23 through a waveguide 22. As the waveguide 22, a coaxial cable, a waveguide tube, or the like can be used. The SDR 23 converts the transmitted analog signal into a digital signal, and the processor 24 identifies a direction of a radio source from the acquired digital signal. The satellite control unit 25 includes an attitude detection device 26 for detecting the current attitude and a rotation control device 27 for rotating the spacecraft 1. As the attitude detection device 26, a star sensor, a sun sensor, an earth sensor, a magnetic sensor, an angular velocity sensor, or the like can be used. In addition, as the rotation control device 27, a reaction wheel, a momentum wheel, a magnetotorquer, a thruster, or the like can be used. Hereinafter, the antenna unit 20 and the processing unit 21 will be described.

### (Antenna Unit 20)

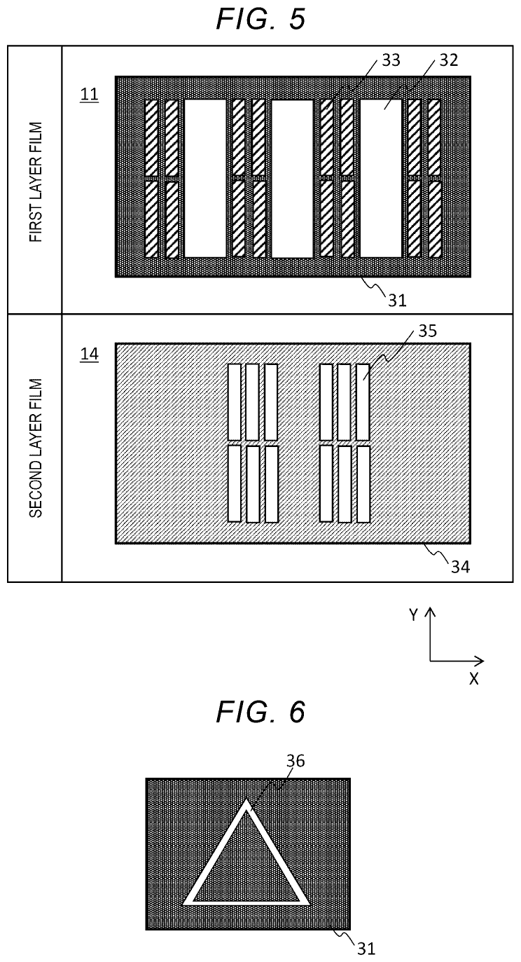

FIG. 5 is a configuration example of the first layer film 11 and the second layer film 14 that configure the antenna unit 20. In the first layer film 11, a film 31 corresponds to the blocking portion 12 (refer to FIG. 2A) and is a dielectric. For example, the film 31 may be a solar panel that generates an operating power of the spacecraft 1. Since the blocking portion 12 is a solar panel, power to be consumed for controlling the rotation of the spacecraft 1 or for controlling the attitude can be supplemented using the power generated from the solar panel. Therefore, the power efficiency can be improved. The film 31 may be a reflector or an absorber as long as it does not allow transmission of an electromagnetic wave. In the film 31, a slit 32 corresponding to the opening 13 and a patch antenna 33 (refer to FIG. 1) are provided. In the second layer film 14, a film 34 is a metal film and may be, for example, a surface of the satellite housing 2 of the spacecraft 1. In order to detect the electromagnetic wave transmitting through the slit 32, a light receiving element group including slot antennas 35 as the light receiving elements 15 is provided. The film 31 and the film 34 may be conductors or insulators. Depending on whether the film 31 and the film 34 are conductors or insulators, the light receiving elements can be adopted. This way, the antenna unit 20 is configured with a void that allows transmission of a part of an electromagnetic wave or a shield that blocks a part of an electromagnetic wave and an antenna that receives an electromagnetic wave. A radio wave can transmit through or be reflected from the first antenna, and interference of diffracted waves can be measured by the second antenna. In addition, the rigidity of the film is not limited. In the film having high rigidity, deformation in the shape of the opening is small, and an interference signal can be more stably measured.

FIG. 5 illustrates an example of the slit where a longitudinal direction is a Y direction as the opening 13, and the longitudinal direction may be directed to any direction. At this time, it is desirable that the slot antennas 35 arranged in the second layer film 14 are arranged such that a change in intensity caused by interference of diffracted waves of the electromagnetic waves transmitting through the slits 32 is reflected as strongly as possible. Accordingly, for example, when the longitudinal direction of the slit 32 is arranged in an X direction, the longitudinal direction of the slot antenna 35 may also be arranged in the X direction.

As the width of the slit, an appropriate width for a wavelength of an arriving electromagnetic wave is considered. The width of the slit may be adjusted according to the wavelength λ of the electromagnetic wave of which the arrival direction is desired to be detected. For example, the width of the slit is considered to be a size that is about 0.2 times the wavelength λ. In addition, a plurality of slits having various widths may be provided in the antenna unit. As a result, arrival directions of electromagnetic waves having various wavelengths can be detected.

The opening 13 provided in the first layer film 11 will be described. The arriving electromagnetic wave transmits through the opening 13 to generate a diffracted wave. Accordingly, instead of the void including no physical structure illustrated in FIG. 5, a material such as glass that allows transmission of an electromagnetic wave may be embedded in the opening 13. Conversely, even in a void such as a metal mesh including no physical structure, when an electromagnetic wave is reflected and cannot transmit through the void, the void does not correspond to the opening according to the present embodiment. In addition, the opening may allow transmission of an electromagnetic wave having a wavelength to be observed, and may be an opening that does not allow transmission of an electromagnetic wave having a wavelength not to be observed. In addition, the opening 13 is not limited to a rectangular shape as in the slit 32. For example, the opening 13 may have a square shape, and a triangular opening 36 illustrated in FIG. 6 may be used. A pattern is formed by interference of electromagnetic waves transmitting through slit-like openings that are sides of the opening 36, and a spatial distribution of the interference pattern changes depending on a change in the incidence angle θ of the electromagnetic wave. Therefore, the opening 36 can be used as the opening 13. This way, when the interference pattern can be formed using one opening 36, one opening may be provided in the film 31. The opening illustrated in FIG. 6 can also be obtained by combining a plurality of slit-like openings having different orientations of the longitudinal direction.

Regarding a positional relationship between the first layer film 11 and the second layer film 14, interference of diffracted waves from the first layer film 11 is sufficient as long as it can be detected by the light receiving element of the second layer film 14. When the single light receiving element is provided, candidates of an incidence angle of an electromagnetic wave can be estimated from a change in signal intensity caused by rotating the spacecraft 1, and the incidence angle can be uniquely detected by further rotating the spacecraft 1. In addition, when a plurality of light receiving elements are provided, candidates of an incidence angle of an electromagnetic wave can be estimated based on relative signal intensities between the plurality of light receiving elements, and the incidence angle of the electromagnetic wave can be uniquely detected from the magnitudes of the signal intensities of the light receiving elements measured when the spacecraft 1 is further rotated. Accordingly, the light receiving elements do not need to be positioned parallel to each other as illustrated in FIG. 2A. Further, the light receiving elements may be arranged such that a diffracted wave from the first layer film 11 is detected by the light receiving element of the second layer film 14 through reflection from another film surface. In addition, an electromagnetic wave may be reflected from a side cross-section of the opening 13 and transmit through the opening 13.

### (Processing Unit 21)

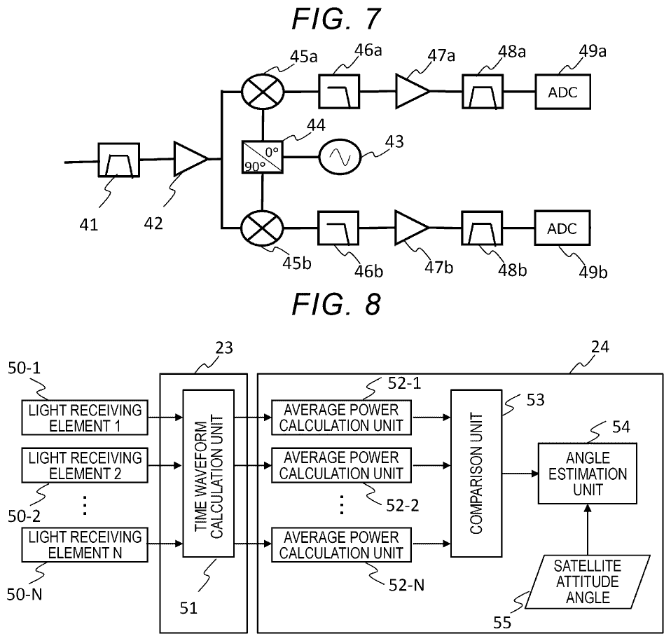

As illustrated in FIG. 4, the analog signal from the light receiving element 15 is transmitted to the SDR 23 through the waveguide 22. The analog signals having the same phase (for example, output signals of the light receiving elements 15a and 15b of FIG. 4) may be combined in the waveguide 22. Optionally, the phase of the analog signal may be adjusted by a phase shifter or a delay circuit. FIG. 7 illustrates an equivalent circuit example of the SDR 23. In the equivalent circuit illustrated in FIG. 7, a real part and an imaginary part when a time waveform of a reception intensity of the electromagnetic wave detected by the light receiving element 15 is expressed by a complex number can be extracted as an output.

The analog signal from the light receiving element 15 is limited in bandwidth by a band pass filter 41 and then is amplified by an amplifier 42. On the other hand, first and second radio frequency signals orthogonal to each other are generated by a local oscillator 43 and a phase shifter 44, and the first and second radio frequency signals are combined with the analog signal from the light receiving element 15 by mixers 45a and 45b, respectively. The combined signal transmits through a low pass filter 46, an amplifier 47, and a band pass filter 48 and is converted into a digital signal by an analog-to-digital converter 49.

The processor 24 estimates an arrival direction of an electromagnetic wave from the time waveform of the signal intensity acquired by the SDR 23 for each of the light receiving elements 15. Hereinafter, the method of estimating an arrival direction of an electromagnetic wave by the processor 24 will be described as an example. The processor 24 functions as a functional unit for providing a predetermined function by executing a process according to a program loaded to a main memory (not illustrated). In the following description, in the process by the program, the functional unit is used as a subject. In this description, a subject of the hardware is the processor 24.

First, a signal processing example where the antenna unit 20 includes the light receiving element group illustrated in FIG. 3 in the second layer film 14 will be described. FIG. 8 is a functional block diagram illustrating an arrival direction estimation process of an electromagnetic wave by the processor 24. The method of estimating the incidence angle θ described above in the description with respect to FIG. 3 is performed. One light receiving element group includes N light receiving elements 50-1 to 50-N.

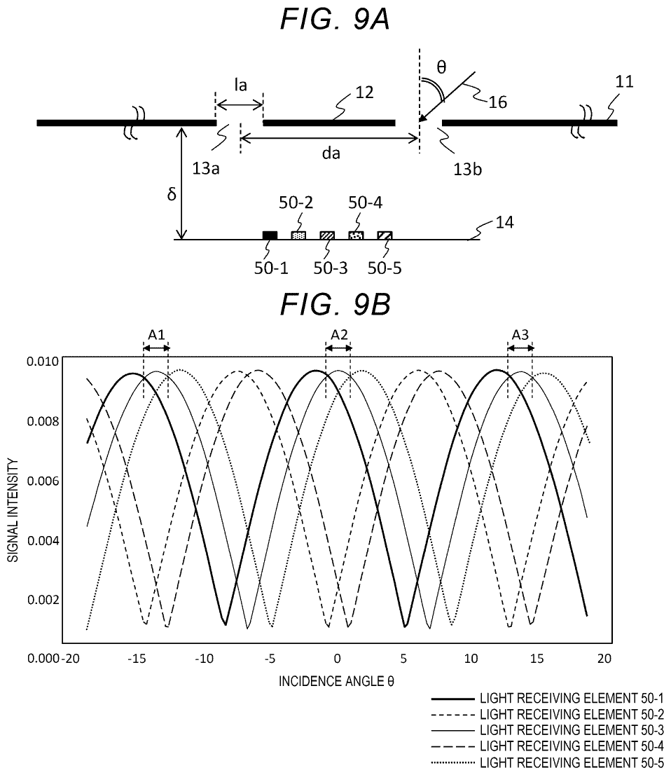

Analog signals from the light receiving elements 1 to N are input to the SDR 23, and time waveforms thereof are calculated. Here, the process of the above-described SDR 23 is described as a time waveform calculation unit 51, and the processing content is a process corresponding to the equivalent circuit illustrated in FIG. 7. An average power calculation unit 52 calculates an average power (signal intensity) from each of time waveforms of the light receiving elements 1 to N. The average power is calculated using data in a period that is longer than at least a signal period. A comparison unit 53 acquires dependence of the magnitudes of the signal intensities of the light receiving elements 1 to N on the change in the incidence angle θ in advance, and estimates the incidence angle θ based on the ranking or the ratio of the sizes of the average powers of the light receiving elements 1 to N. FIG. 9A illustrates an example of the antenna unit 20 where N=5, and FIG. 9B illustrates the incidence angle θ dependence of the signal intensity of each of the light receiving elements 50-1 to 50-5 when predetermined parameters are assigned to an opening length la, an opening interval da, and an inter-film distance δ of the opening 13 to perform a simulation. For example, when the light receiving element 50-3 has the maximum signal intensity, the incidence angle θ can be estimated to be a value representing any of ranges A1, A2, and A3. For example, the incidence angle θ is output as a median value of the ranges A1, A2, and A3. Here, for convenience of description, (A1, A2, A3)=(−14°, 0°, 14°) is expressed.

Next, the spacecraft 1 is rotated to change a satellite attitude angle 55, and the incidence angle θ is estimated as described above. Here, a case where an arrival direction of an electromagnetic wave is a direction of A2 when the satellite attitude angle 55 is 0° is assumed. In this case, even when the satellite attitude angle 55 is inclined to −14° or 14°, the signal intensity increases. However, when the satellite attitude angle 55 is inclined to 28°, it is difficult to receive an electromagnetic wave at the orientation of the antenna unit such that the signal intensity decreases. By changing the satellite attitude angle 55 as described above, not only the incidence angle θ of the electromagnetic wave but also the signal intensity of the light receiving element 50 change.

On the other hand, assuming that an arrival direction of an electromagnetic wave is a direction of A3 when the satellite attitude angle 55 is 0°, even when the satellite attitude angle 55 is inclined to 14° or 28°, the signal intensity increases. However, when the satellite attitude angle 55 is inclined to −14°, the signal intensity decreases. This way, by changing the satellite attitude angle 55, the incidence angle candidates can be narrowed.

This way, an angle estimation unit 54 estimates the arrival direction of the electromagnetic wave based on the incidence angle θ estimated by the comparison unit 53 and the satellite attitude angle 55 from the attitude detection device 26. That is, the electromagnetic wave arrival direction can be uniquely determined from the estimated incidence angle θ and the satellite attitude angle 55. Here, the example of calculating the average power from the time waveform of each of the light receiving elements 1 to N as the signal intensity is shown. As the signal intensity, a maximum amplitude value obtained from the time waveform of the signal may be calculated.

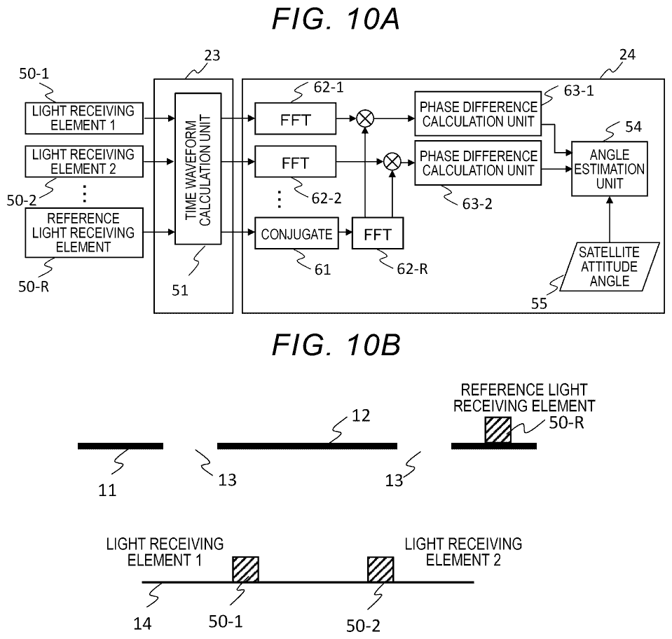

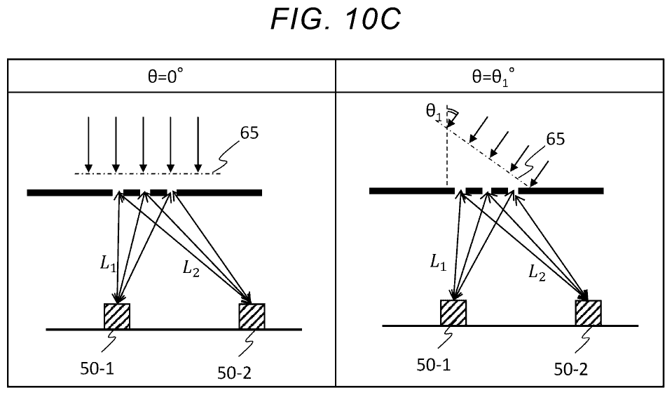

FIG. 10A is a functional block diagram illustrating the arrival direction estimation process of the electromagnetic wave that is performed by the processor 24 using another estimation method at the incidence angle θ. FIG. 10B illustrates a configuration of the antenna unit 20 that performs the arrival direction estimation process of the electromagnetic wave illustrated in FIG. 10A. In this example, the light receiving element (for example, the patch antenna 33 (refer to FIG. 5)) provided in the first layer film 11 is used as a reference light receiving element 50-R in the estimation process. The method of estimating the incidence angle θ in the present example will be described using FIG. 10C. As illustrated in FIG. 10C, inclinations of electromagnetic waves having different incidence angles with respect to an equiphase surface 65 are different. Therefore, phases of the diffracted waves 17 generated in the respective openings 13 change depending on the incidence angle θ. Therefore, interference patterns generated from the light receiving elements 50-1 and 50-2 are different depending on the incidence angle θ.

An analog signal from the reference light receiving element is input to the SDR 23, and a time waveform is calculated. The time waveform where a phase component is inverted by a conjugated portion 61 is converted into a frequency spectrum by fast Fourier transformation (FFT) 62-R. On the other hand, analog signals from the light receiving elements 1 to N are input to the SDR 23, and a time waveform of each of the analog signals is calculated. Each of the time waveforms of the light receiving elements 1 to N are converted into a frequency spectrum by the FFT 62, and is integrated with the frequency spectrum of the reference light receiving element where the phase component is inverted. As a result, a cross spectrum of the signal of the reference light receiving element and the signal of each of the light receiving elements is calculated. In a phase difference calculation unit 63, a phase difference between the signal of the reference light receiving element and each of the light receiving elements is calculated from the input cross spectrum. The angle estimation unit 54 estimates the incidence angle θ from the phase difference in each of the light receiving elements calculated by the phase difference calculation unit 63-1 to 63-N, and estimates the arrival direction of the electromagnetic wave based on the satellite attitude angle 55 from the attitude detection device 26. By using the reference light receiving element, the incidence angle can be estimated from the phase difference instead of the magnitude of the signal, and even when a signal having a low intensity of which the magnitude is difficult to detect is used, an arrival direction of an electromagnetic wave can be accurately estimated.

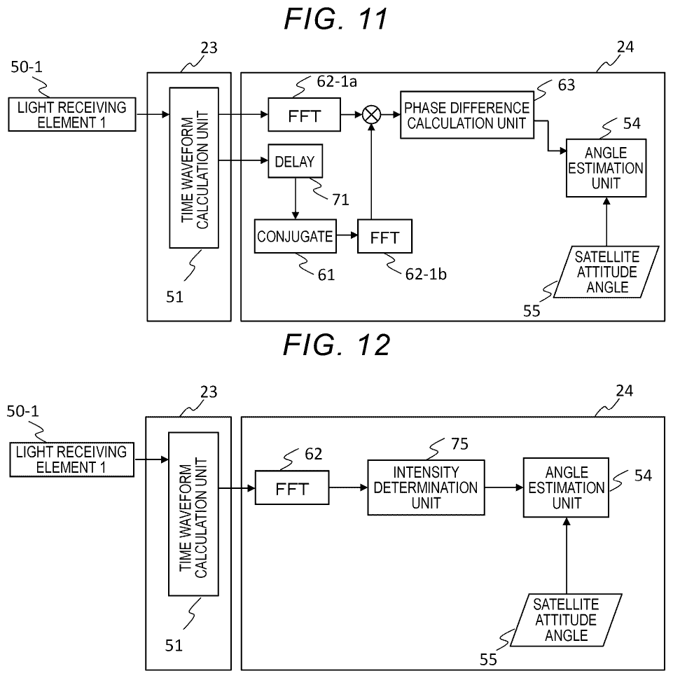

FIG. 11 is a functional block diagram illustrating an arrival direction estimation process of an electromagnetic wave in which a change over time in the arrival direction of the electromagnetic wave is estimated by the processor 24 using any light receiving element. The estimation method is as described above with reference to FIG. 10C. In FIG. 11, regarding the same light receiving element (for example, the light receiving element 1), the phase difference is calculated based on a frequency spectrum before a predetermined time using a delay unit 71. As a result, a phase difference corresponding to a change in incidence angle can be measured, the incidence angle can be estimated from the phase difference, and an arrival direction of an electromagnetic wave can be estimated.

FIG. 12 is a functional block diagram illustrating an arrival direction estimation process of an electromagnetic wave by the processor 24 when an electromagnetic source emits an incoherent electromagnetic wave. In the case of the incoherent electromagnetic wave, the signal intensity is strong at a specific incidence angle θ due to interference of a plurality of diffracted waves. Therefore, the intensity of the frequency spectrum of the electromagnetic wave can be determined by an intensity determination unit 75, and a direction of an electromagnetic source can be estimated.

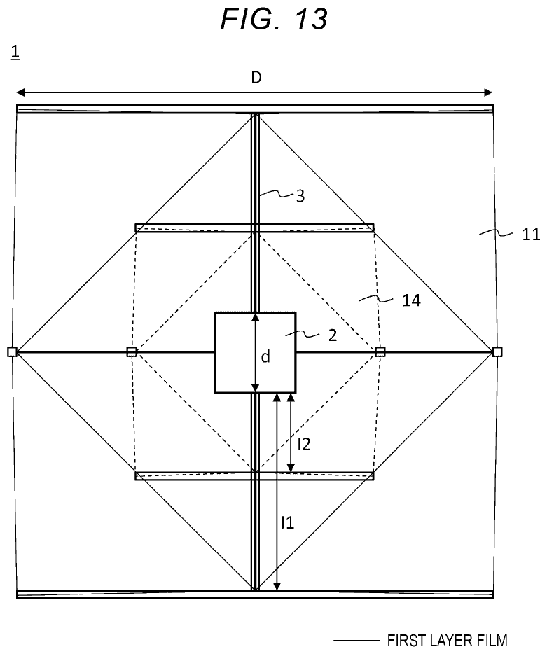

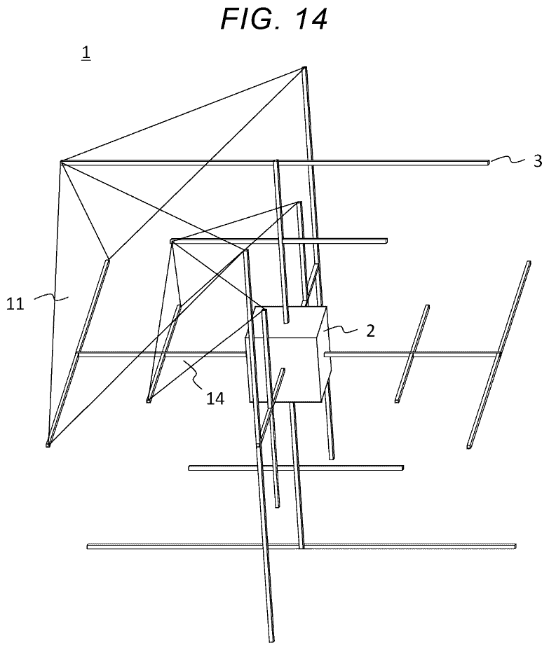

Hereinafter, an example where the electromagnetic wave observation system according to the present embodiment is installed on the spacecraft 1 will be described. FIG. 13 is a side view illustrating the spacecraft 1, and FIG. 14 is a bird's-eye view illustrating the spacecraft 1. It is assumed that the frequency of an electromagnetic wave to be observed is 2 GHZ (observation wavelength λ=15 cm) and the size of the spacecraft 1 is, for example, D=120 cm, d=20 cm, l1=40 cm, and l2=20 cm. Here, regarding the beam 3, a beam having one end connected to the satellite housing 2 after deployment will be referred to as a vertical beam, and a beam provided to be orthogonal to the vertical beam will be referred to as a horizontal beam. A long horizontal beam is provided at a tip of one vertical beam, a short horizontal beam is provided in the middle of the vertical beam, the triangular first layer film 11 is attached to a tip of the long horizontal beam, and the triangular second layer film 14 is attached to a tip of the short horizontal beam. Further, a dipole antenna can be installed in the beam 3.

In the interferometric measurement according to the present embodiment, the spacecraft 1 that has a three-dimensional structure and includes a multilayer film is used. For example, a configuration where the first layer film 11 is a thin film attached to the beam and the second layer film 14 is a surface of the satellite housing 2 can be adopted. Alternatively, in a spacecraft where the thin film is deployed in multiple regions as illustrated in FIG. 13, a configuration where the first layer film 11 is an external thin film (film far from the satellite housing 2) and the second layer film 14 is an internal thin film (film close to the satellite housing 2) can be adopted. As a result, by utilizing the configuration where the spacecraft 1 has a three-dimensional structure, a diffracted radio wave is generated using the external film surface. Next, an interference fringe can be measured by an antenna installed on the inside. The angular resolution of the arrival direction detection can be increased by the multilayer detection using the void and slit. By using the two layer films, the inter-film distance can be used as a parameter, and thus the number of interference fringes can be increased. In addition, the measurement can be performed while increasing the number of observation points. On the other hand, by adopting the configuration where the first layer film 11 is the thin film and the second layer film 14 is the surface of the satellite housing 2, the three-dimensional structure of the spacecraft can be made structurally simpler.

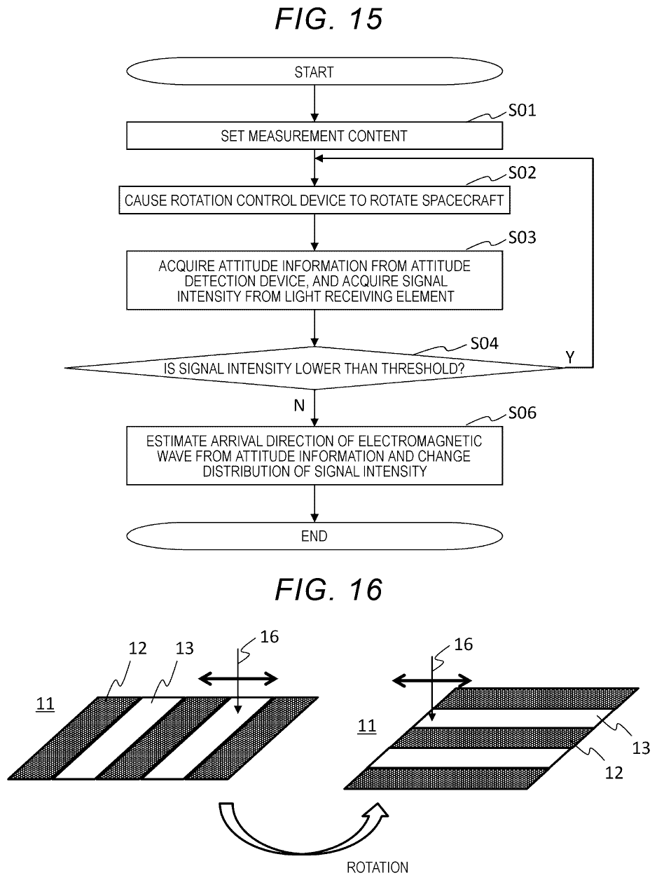

FIG. 15 illustrates a flow of estimating a radio source direction using the electromagnetic wave observation system according to the present embodiment while controlling the attitude of the spacecraft 1. The processing unit 21 (processor 24) sets a measurement content (S01), and causes the rotation control device 27 to rotate the spacecraft 1 around a rotation axis parallel to a normal line of the first layer film 11 (S02). Attitude information (satellite attitude angle 55) is acquired from the attitude detection device 26, and the signal intensity from the light receiving element 15 is acquired (S03). The processor 24 compares the signal intensity to a preset threshold (S04), and when the signal intensity is lower than the threshold, causes the rotation control device 27 to rotate the spacecraft 1 around the rotation axis parallel to a normal line of the first layer film 11 (S02). The reason for this will be described using FIG. 16. In a case where the opening 13 of the first layer film 11 has a shape that is long only in one direction as in the slot, when a polarization direction of the electromagnetic wave 16 is orthogonal to the longitudinal direction of the slot, the electromagnetic wave 16 cannot transmit through the opening 13, and the signal intensity is extremely low. Accordingly, by causing the rotation control device 27 to rotate the first layer film 11 in a direction in which the signal intensity received by the light receiving element increases, for example, the polarization direction of the electromagnetic wave 16 and the longitudinal direction of the slot can be made the same. As a result, the electromagnetic wave transmitting through the opening 13 can be maximized. When a sufficient signal intensity can be obtained from the light receiving element, an arrival direction of an electromagnetic wave is estimated by the above-described multilayer interferometric method (S06).

When not only the slot-like openings having the same longitudinal direction but also, for example, a plurality of slot-like openings having different orientations of the longitudinal direction as in FIG. 6 are formed in the first layer film 11 as the opening 13 of the first layer film 11, a decrease in signal intensity caused by the polarization direction can be suppressed, and thus the effect of making the flow of FIG. 15 unnecessary is obtained.

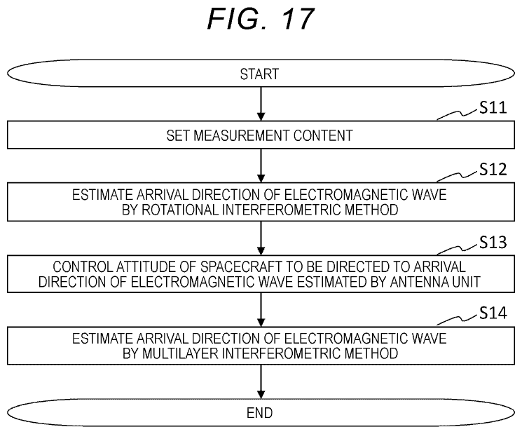

FIG. 17 illustrates a flow of estimating a radio source direction by a combination of the rotational interferometric method using the pair of dipole antennas and the multilayer interferometric method using the antenna unit according to the present embodiment when the dipole antenna is installed on the beam 3 of the spacecraft 1. The processor 24 sets the measurement content (S11), and estimates the arrival direction of the electromagnetic wave by the rotational interferometric method (S12). In the rotational interferometric method, an electromagnetic wave from an electromagnetic source is received by the pair of dipole antennas while causing the rotation control device 27 to rotate the spacecraft 1 around the rotation symmetry axis, and the received electromagnetic waves interfere with each other to generate an interference fringe, and an arrival direction of the electromagnetic wave is estimated using the interference fringe. In the spacecraft 1 illustrated in FIGS. 13 and 14, the longest distance between the pair of dipole antennas is represented by D. Therefore, when the observation wavelength λ is 15 cm, a spatial resolution (λ/D) in Step S02 is about 7.2°. The processor 24 controls the attitude of the spacecraft 1 to be directed to the arrival direction of the electromagnetic wave estimated by the antenna unit 20 in Step S02 (S13), and estimates the arrival direction of the electromagnetic wave by the multilayer interferometric method (S14). By appropriately setting the parameters of the antenna unit 20 (refer to FIG. 9A), the spatial resolution of the multilayer interferometric method can be set to be higher than the spatial resolution of the rotational interferometric method. By using the multilayer interferometric method in a high-accuracy measurement mode, the efficiency of the measurement can be improved.

Hereinafter, modification examples of the present embodiment will be described.

### First Modification Example

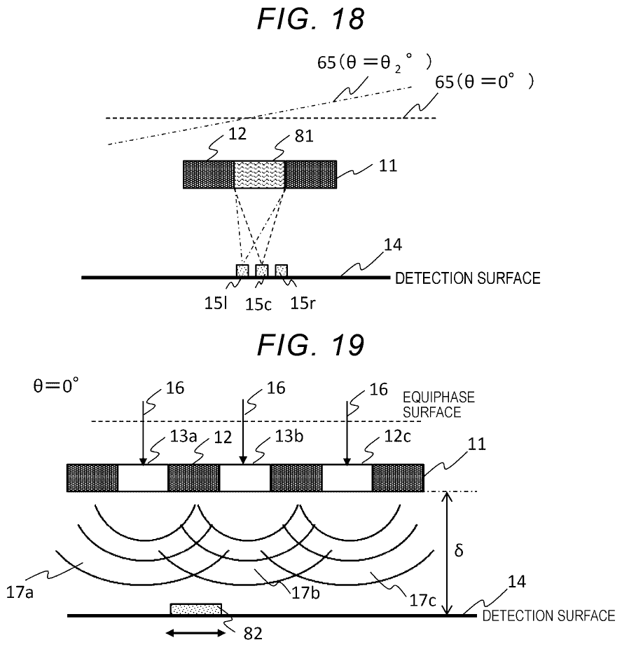

In FIG. 18, a dielectric lens 81 is provided in the opening of the first layer film 11. When the incidence angle θ of the electromagnetic wave changes, a focal position of the dielectric lens 81 deviates. By using this property, the incidence angle θ can be estimated from the deviation in the focal position.

### Second Modification Example

FIG. 3 illustrates the example where the plurality of light receiving elements are arranged on the detection surface. On the other hand, FIG. 19 illustrates an example where a light receiving element 82 that is movable on the detection surface is used. As the drive source of the light receiving element 82, for example, a motor is used. By moving the light receiving element for the measurement, the installation of the plurality of light receiving elements is unnecessary, which leads to a reduction in manufacturing costs.

### Third Modification Example

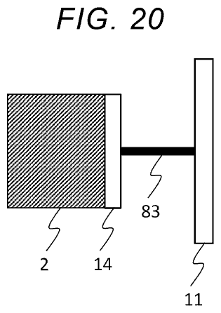

The spacecraft having a tensegrity structure is used as the example of the spacecraft according to the present embodiment, but the present invention is not limited thereto. FIG. 20 illustrates an example where the first layer film 11 is arranged at a position far from the second layer film 14 using a stretchable structure such as a tether 83. As a result, the distance can be freely and variably set using the stretchable structure such as the tether. In a spacecraft not having a tensegrity structure, the spacecraft itself may rotate, or a part of the spacecraft including the antenna unit may rotate.

### Fourth Modification Example

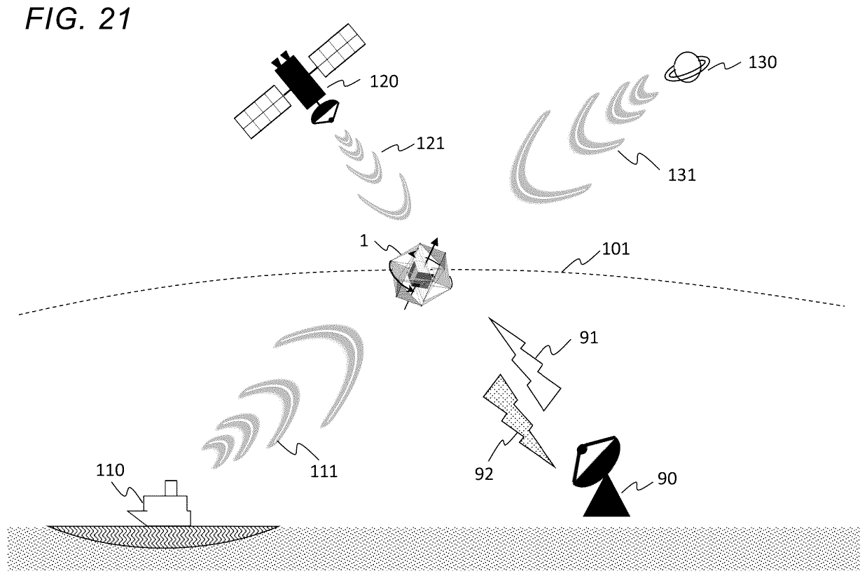

FIG. 21 illustrates a configuration example of the electromagnetic wave monitoring system including the spacecraft 1 described above as the present embodiment and the modification examples. The spacecraft 1 that moves on an orbit 101 around the earth receives an electromagnetic wave 111 from an electromagnetic wave source 110 relating to artificial activities on the earth, an electromagnetic wave 121 from an electromagnetic wave source 120 relating to artificial activities of the space, or an electromagnetic wave 131 from an astronomical object 130, and communicates (downlink 91 of data and an uplink 92 of a command) with a ground station (base station) 90 installed on the earth. The spacecraft 1 is arranged in various orbits such as a low orbit, an intermediate orbit, an geostationary orbit, and a cislunar orbit depending on the observation target. Here, the arrangement assuming the low orbit is illustrated. The observation target is all of the electromagnetic waves around the spacecraft 1 including an electromagnetic wave illustrated in FIG. 21.

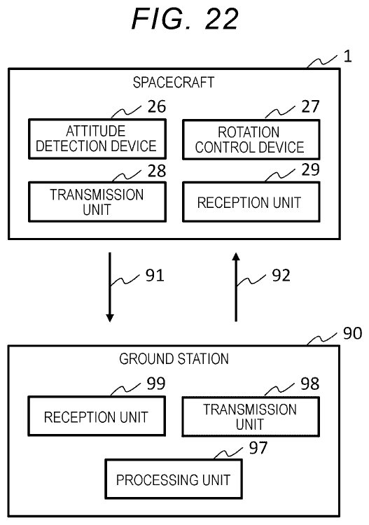

FIG. 22 is a diagram illustrating a configuration of the spacecraft 1 and a ground station 90. The ground station 90 includes a processing unit 97, a transmission unit 98, and a reception unit 99, and the spacecraft 1 includes a transmission unit 28 and a reception unit 29 in addition to the attitude detection device 26 and the rotation control device 27 illustrated in FIG. 4. The reception units 29 and 99 demodulate a radio frequency signal transmitted from an opposite party, and decodes a signal that can be processed by the processor. In addition, the transmission units 28 and 98 encode a signal transmitted from the opposite party, and modulates the encoded signal into a radio frequency signal. The encoding/decoding method and the modulation/demodulation method are not limited. In this configuration, the estimation of the arrival direction of the electromagnetic wave using the spacecraft 1 illustrated in the flow of FIG. 17 is executed in the following procedure. The signal intensity of the electromagnetic wave detected by the light receiving element of the spacecraft 1 and the information regarding the attitude of the spacecraft are downlinked from the transmission unit 28 to the reception unit 99 of the ground station 90. In the ground station 90, a command regarding the rotation control of the spacecraft 1 is uplinked from the transmission unit 98 to the reception unit 29 of the spacecraft 1 based on the signal intensity of the electromagnetic wave received by the reception unit 99. According to the command, the spacecraft 1 observes the electromagnetic wave while rotating the airframe. Next, the signal intensity of the electromagnetic wave detected by the light receiving element of the spacecraft 1 and the information regarding the attitude of the spacecraft are downlinked again from the transmission unit 28 to the reception unit 99 of the ground station 90. Next, the processing unit 97 of the ground station 90 estimates the arrival direction of the electromagnetic wave based on the signal intensity of the electromagnetic wave and the attitude of the spacecraft that are downlinked. The details of the process of estimating the arrival direction of the electromagnetic wave by the processing unit 97 are the same as the process that is performed by the processing unit 21 illustrated in FIG. 4.

In the fourth modification example, the process of estimating the arrival direction of the electromagnetic wave in the electromagnetic wave monitoring system is performed in the ground station 90. The processing unit 97 may be installed on the spacecraft 1 side, and the process may be performed in a form where the command to be processed by the processing unit 97 is uplinked from the transmission unit 98 of the ground to the spacecraft 1.

The processor 24 of the spacecraft in the embodiment or the processor of the ground station in the fourth modification example performs a process of determining an arrival direction of an electromagnetic wave according to a program loaded to a main memory (not illustrated). The program includes programs described below.

(1) A program causing a processor to estimate an incidence angle of an electromagnetic wave with respect to a first layer film 11 from a signal intensity of a coherent electromagnetic wave transmitting a plurality of openings, the signal intensity being detected by an antenna unit including the first layer film 11 and a second layer film 14, the first layer film 11 including a plurality of slit-like openings 13 in a film that does not allow transmission of an electromagnetic wave having a wavelength to be observed, and the second layer film 14 including a light receiving element 15.

(2) In the program, when a plurality of the light receiving elements 15 are provided in the second layer film 14, the processor estimates the incidence angle of the electromagnetic wave with respect to the first layer film 11 based on relative signal intensities detected by the plurality of light receiving elements 15.

(3) In the program, the processor estimates the incidence angle of the electromagnetic wave with respect to the first layer film 11 based on a change in the signal intensity of the electromagnetic wave detected by the light receiving element 15 while causing the rotation control device 27 that rotates the spacecraft 1 to rotate the spacecraft 1 to change the incidence angle.

(4) In the program, the processor estimates an arrival direction of the electromagnetic wave based on a satellite attitude angle detected by an attitude detection device 26 that detects an attitude of the spacecraft 1 while causing the rotation control device 27 to rotate the spacecraft 1 and the estimated incidence angle of the electromagnetic wave with respect to the first layer film 11.

(5) In the program, when the signal intensity of the electromagnetic wave detected by the light receiving element 15 is lower than a threshold, the processor issues a command for causing the rotation control device 27 to rotate the spacecraft 1 around a rotation axis parallel to a normal line of the first layer film 11.

The present invention is not limited to the embodiment and includes various modification examples. For example, the embodiment has been described in detail in order to easily describe the present disclosure, and the present invention is not necessarily to include all the configurations described above. In addition, a part of the configuration of one embodiment or modification example can be replaced with the configuration of another embodiment or modification example. Further the configuration of one embodiment or modification example can be added to the configuration of another embodiment or modification example. In addition, addition, deletion, and replacement of another configuration can be made for a part of the configuration of each of the embodiment and modification examples.

In addition, some or all of the above-described functional units executed by the software program in the description may be implemented by hardware, for example, by designing an integrated circuit. Information of a program, a table, a file, or the like that implements each of the functions can be stored in a recording device such as a memory, a hard disk, or a solid state drive (SSD) or a recording medium such as an IC card, a memory card, or an optical disk.

What is claimed is:

1. A spacecraft comprising:
an antenna unit including a first layer film and a second layer film, the first layer film including a plurality of slit-like openings in a film that does not allow transmission of an electromagnetic wave having a wavelength to be observed, and the second layer film including a light receiving element that detects a coherent electromagnetic wave transmitting through the plurality of openings; and
a processing unit configured to estimate an arrival direction of the electromagnetic wave from a signal intensity of the electromagnetic wave detected by the light receiving element.

2. The spacecraft according to claim 1,
wherein a plurality of the light receiving elements are provided in the second layer film, and
the processing unit estimates an incidence angle of the electromagnetic wave with respect to the first layer film based on relative signal intensities of the electromagnetic wave detected by the plurality of light receiving elements.

3. The spacecraft according to claim 1, further comprising a rotation control device configured to rotate the spacecraft,
wherein the processing unit estimates an incidence angle of the electromagnetic wave with respect to the first layer film based on a change in the signal intensity of the electromagnetic wave detected by the light receiving element while causing the rotation control device to rotate the spacecraft to change the incidence angle of the electromagnetic wave with respect to the first layer film.

4. The spacecraft according to claim 1, further comprising:
a satellite housing; and
a plurality of beams deployed from the satellite housing,
wherein each of the first layer film and the second layer film is a thin film stretched by the plurality of beams, or the first layer film is a thin film stretched by the plurality of beams and the second layer film is a surface of the satellite housing.

5. The spacecraft according to claim 1, further comprising:
an attitude detection device configured to detect an attitude of the spacecraft; and
a rotation control device configured to rotate the spacecraft,
wherein the processing unit estimates the arrival direction of the electromagnetic wave based on a satellite attitude angle detected by the attitude detection device while causing the rotation control device to rotate the spacecraft and an estimated incidence angle of the electromagnetic wave with respect to the first layer film.

6. The spacecraft according to claim 5,
wherein when the signal intensity of the electromagnetic wave detected by the light receiving element is lower than a threshold, the processing unit causes the rotation control device to rotate the spacecraft around a rotation axis parallel to a normal line of the first layer film.

7. The spacecraft according to claim 5, further comprising:
a satellite housing; and
a plurality of beams deployed from the satellite housing,
wherein a dipole antenna is provided in the beam, and
the processing unit estimates the arrival direction of the electromagnetic wave based on an interference output of electromagnetic waves received by a pair of the dipole antennas while causing the rotation control device to rotate the spacecraft, and controls the rotation control device such that the first layer film is directed to the estimated arrival direction of the electromagnetic wave.

8. The spacecraft according to claim 1,
wherein a longitudinal direction of the opening and a longitudinal direction of the light receiving element are arranged in the same direction.

9. The spacecraft according to claim 1,
wherein the plurality of openings provided in the first layer film include openings having different orientations of a longitudinal direction.

10. The spacecraft according to claim 1,
wherein the first layer film is a solar panel.

11. A ground station that performs transmission and reception with a spacecraft including an antenna unit and estimates an arrival direction of an electromagnetic wave having a wavelength to be observed,
the antenna unit including a first layer film and a second layer film,
the first layer film including a plurality of slit-like openings in a film that does not allow transmission of an electromagnetic wave,
the second layer film including a light receiving element that detects a coherent electromagnetic wave transmitting through the plurality of openings, and
the ground station comprising:
a reception unit configured to receive a signal intensity of the electromagnetic wave detected by the light receiving element, the signal intensity being downlinked from the spacecraft; and
a processing unit configured to estimate the arrival direction of the electromagnetic wave from the signal intensity of the electromagnetic wave received by the reception unit.

12. The ground station according to claim 11,
wherein a plurality of the light receiving elements are provided in the second layer film of the antenna unit of the spacecraft, and
the processing unit estimates an incidence angle of the electromagnetic wave with respect to the first layer film based on relative signal intensities of the electromagnetic wave detected by the plurality of light receiving elements.

13. The ground station according to claim 12,
wherein the reception unit receives a satellite attitude angle of the spacecraft, and
the processing unit estimates the arrival direction of the electromagnetic wave from the satellite attitude angle and the estimated incidence angle of the electromagnetic wave with respect to the first layer film.

14. The ground station according to claim 11, further comprising a transmission unit configured to uplink a command to the spacecraft,
wherein when the signal intensity of the electromagnetic wave detected by the light receiving element is lower than a threshold, the processing unit transmits a command to the spacecraft to rotate the spacecraft around a rotation axis parallel to a normal line of the first layer film.

15. An antenna comprising:
a first layer film including a plurality of slit-like openings in a film that does not allow transmission of an electromagnetic wave; and
a second layer film where a light receiving element is provided to estimate an incidence angle of the electromagnetic wave with respect to the first layer film based on a signal intensity of a coherent electromagnetic wave transmitting through the plurality of openings.
